(19) United States
(12) Patent Application Publication
(10) Pub. No.: US 2017/0127672 A1
(43) Pub. Date: May 11, 2017

(54) HAND DISINFECTANTS

(71) Applicant: Hans Georg HAGLEITNER, Zell am See (AT)

(72) Inventor: Herbert Widulle, Hamburg (DE)

(21) Appl. No.: 15/305,163

(22) PCT Filed: Apr. 17, 2015
(86) PCT No.: PCT/EP2015/058446

§ 371 Date: Dec. 27, 2016

(30) Foreign Application Priority Data
Apr. 19, 2014 (DE) 10 2014 005 807.7

(51) Int. Cl. A01N 33/12

(52) U.S. Cl. CPC A01N 33/12

(57) ABSTRACT

The invention relates to hand disinfectants, containing at least 40 weight percent of water and at least one dissolving ether, wherein the at least one dissolving ether is an ether that has a molecular weight greater than 107 daltons, a melting point less than 303 K, and a boiling point greater than 373 K, the solubility in water of the ether being at least 50%, wherein the ether reduces the solubility of calcium adducts and magnesium adducts of proteins and of amino sugars in water at least to a half, preferably to a third, especially preferably to a fourth, in particular to a fifth. Said hand disinfectants can be used as monoalcohol-free hand disinfectants.

### PRIOR ART

The present invention relates to a hand disinfectant, wherein the hand disinfectant contains at least 40 w % water and at least one dissolving ether.

The state of the art for hand disinfectants is described by the test methods, in which an agent is examined in regard to its efficiency. Currently, all agents, which are to be approved for hygienic hand disinfection, have to be examined according to standard EN1500. The EN 1500 uses as a microbicidal reference substance 60% 2-propanol (vol/vol) in water. The reference substance, 60% 2-propanol (vol/vol), results in slowly effective active agents, such as, e.g., chlorohexidine digluconate, not being able to pass the tests, as the maximum allowed dwell time of the test substance will have been exceeded by the onset of the effect. The EN 1500 prefers quickly effective disinfectants like ethanol and propanols as well as chlorine and oxygen cleavers. The test method, however, also leads to the skin of the user not being protected against pathogens following disinfection, such as, for example, would be the case for a disinfection using chlorohexidine. The common contents of less than one percent quaternary ammonium compounds and hand disinfectants containing ethanol or propanol as an active agent do not cause long-term effects, as test results according to the standards for chirurgical hand disinfection illustrate. In these cases, the effectiveness of alcoholic hand disinfectants with or without the addition of quaternary ammonium compounds is more or less the same. It has also been known that products are possible, which contain as an active agent about 4% of a quaternary ammonium compound or a guanidine and contain, apart from this compound, as many solubilizers like propylene glycol, butylene glycol and other polyalcohols, so that the products have a degreasing effect on the skin. Unfortunately, all of these products were effective only according to the new standards EN 1499, hand decontamination, which have to meet less requirements than the EN 1500. Agents, which only have to meet the requirements of the EN1499, have to be better than soap in a comparative test. Whereas for passing the EN 1500, in general a microbial reduction of 4.5 log increments is required, passing the EN 1499 in general requires 3 log increments, this is only 3 percent of the reduction required by the EN 1500. None of these products obtained the same effectiveness as ethanol.

Many years ago, experiments showed that emulsions using the quaternary ammonium compounds as emulsifiers did not display any microbicidal effect on the hands according to the test methods of the DGHM. These products are neither sufficiently effective for a hygienic hand disinfection according to EN1500 nor for a hand decontamination according to EN1499, nevertheless meeting the standards for a chirurgical hand disinfection. The products did not show degreasing of the skin and were very pleasant in application, but they were, however, not or only insufficiently effective.

A further disadvantage of the alcoholic hand disinfectants is the high evaporation rate of the ethanol or propanol. The high volatility leads to the fact that for the complete moisturization of the entire skin of the hands there is required more of the agent than corresponds to the volume of the skin on the hands. The epidermis, which is the only one being soaked by the alcoholic agent, has an overall volume of one cubic centimetre on both hands. In spite thereof, at least 3 ml, this is more than triple the volume, are required in order to disinfect the skin even for a short period of time. If the user is not sufficiently skilled in the process of disinfection, even this amount will not suffice.

In several European countries it is not possible anymore to offer alcoholic hand disinfectants in discharge means freely accessible for anybody, as would be required for a sufficient hygiene in hospitals. The reason therefore is the large number of alcoholics among a part of the population, even though a small one. This part of the population seriously addicted to alcohol will drink hand disinfectants in spite of denaturing according to standards and even though the agents do not contain ethanol but rather propanols.

In rooms, in which no electric devices are being used, the room temperature has to be below the flash point of the hand disinfectant, for some alcoholic products below 23° C., as otherwise this might result in explosions due to electric sparks, originating from the devices. The use of alcoholic hand disinfectants in the vicinity of active medicinal products based on electric power supply, hence, is only possible ignoring any safety standards.

The use of hypochlorite products, which has been propagated lately, is to be rejected because of the massive skin damage. In the case of skin damage, it is irrelevant whether alkali hypochlorite has been used or chlorinated lime, as suggested by Dr. Ignaz Semmelweis in the middle of the 19^{th} century in Vienna at his obstetric clinic. The damage in the skin is produced by oxidation and chlorination of integral parts of the cells. In this way, it is theoretically possible that the integral parts of the cells that are damaged by the agent may be brought into contact with the viable skin, consequently causing allergies. As this fact has been known for many years, the pharmacopoeias restrict the use of hydrogen peroxide on skin or wounds to a 3% solution, which is not effective according to EN 1499 or EN 1500.

All this shows that it is necessary to make available a hand disinfectant, which is effective at least according to the EN 1500 and which does not contain any highly volatile alcohols and/or any skin damaging compounds such as hypochlorite, chlorite, chlorate, peroxide or peroxy acid.

A safe hand disinfectant without ethanol, which is at least as good as required by EN 1500, hence is so imperative so that recently products have been marketed, which contain as active agents only quaternary ammonium compounds or hexetidine or guanidine and which, nevertheless, have been able to pass the EN1500. Re-examination by the inventor using several of his own or other products, which have all been formed on the basis of quaternary ammonium compounds or hexetidine or guanidine without ethanol, propanols or glycols, showed that none of these agents was comparably good or even significantly not worse than the reference substance 60% 2-propanol (vol/vol).

### DESCRIPTION OF THE INVENTION

The task was solved by a hand disinfectant of the type initially mentioned in a way such that the at least one dissolving ether is an ether having a molecular weight of more than 107 Dalton, a melting point lower than 303 K and a boiling point higher than 373 K, the solubility of which in water being at least 50% and wherein the ether reduces the solubility of calcium and magnesium adducts of proteins and amino sugars in water to at least the half, preferably to a third, especially preferably to a fourth, in particular to a fifth.

A solubility of the ether in water of at least 50% thereby means that a solution of 50 w % ether or more in water will give a clear solution. Preferably, the solubility of the ether in water is at least 70%, especially preferably at least 80%, in particular 90%. In particular preferably, the ether is completely miscible in water.

Especially suitable as dissolving ethers are, for that matter, in the sense of the invention glycol ether, in particular dipropylene glycols, tripropylene glycols or tetrapropylene glycols.

Surprisingly, and also completely as a surprise to the person skilled in the art, it has been shown that in this way it is possible to formulate hand disinfectants, which contain neither ethanol nor a propanol, nor any other alcohol having less than 9 carbon atoms and which are nevertheless as effective as 60% 2-propanol (vol/vol), if tested according to EN 1500. Even more surprising was that the products according to the invention under identical conditions showed a more uniform effect than the alcoholic products according to prior art. The lower range of fluctuation of the microbial reduction in the hand disinfectants will increase the safety of this hygienic measure, as negative outliers having reduced microbial reduction and, hence, dangerously high microbial load on the hands following hand disinfection are less frequent than with the alcoholic comparative product according to prior art.

Unless stated otherwise, all percentages are % by weight.

The disinfectant preferably further contains at least one fatty entity, wherein the fatty entity is a non-polymeric compound, namely an ester, ether, ketone or alcohol, except for monoalcohols having a chain length of 1 to 8 carbon atoms, wherein the fatty entity has a low solubility in water of at the most 3 w % and at the lowest 0.01 w %, wherein the fatty entity has a molecular weight of more than 107 Dalton, a melting point lower than 303 K, a boiling point higher than 373 K and wherein the content of fatty entities is larger than the solubility of the compound in water. Especially preferably, the fatty entity is an ester or alcohol.

Non-polymeric compounds are such compounds, in the molecule of which no monomeric part differing from a CH2 moiety, is used in a sequence more than twice.

Such products are based on the finding that all liquid organic compounds having a limited solubility in water are microbicidally effective. This has already been described in the Wallhäuβer of 1988, K.H. Wallhäuβer, G. Thieme Verlag Stuttgart, 4^{th} ed., page 427, for medium-chain alcohols having a chain length of up to eight carbon atoms. Wallhäuβer, however, indicates in the standard publication, named after him, that these medium-chain alcohols would not have any significance for disinfection and in particular the disinfection of hands, as the low water solubility would prevent any rapid onset of effects. This has also been known for essential oils, which all fall into the scope of this definition, for a long time. These oils, however, are not to be used in hand disinfectants because of their degreasing effect and the sensibilizing effect thereof onto the skin. It has been further known that quaternary ammonium compounds, guanidine or hexetidine without any further active agents such as ethanol, propanol, propylene glycol, butane diol or glycerol, this is only in combination with alcohols or glycols having a molecular weight of less than 100 Dalton and complete solubility in water, will not pass the EN1500 in concentrations of more than four percent, if the percentage of alcohols or glycols in itself is not already sufficiently microbicidal according to EN 1500.

Dissolving ethers and fatty entities independently of each other preferably have a melting point below 293 K, preferably below 283 K, especially preferably below 273 K.

As fatty entities, there are in particular suitable such compounds, which have at least one branch or an aliphatic or aromatic ring in their carbon skeleton.

The dissolving ethers according to the invention are effective as solubilizers for the fatty entities that are soluble in water only to a limited extent.

Especially suitable as dissolving ethers in the sense of the invention are glycol ethers, in particular dipropylene glycols, tripropylene glycols or tetrapropylene glycols.

Further suitable ethers are butyl diglycols or butylene dipropylene glycols or also di-n-butyl ethers, di-n-pentyl ethers, pentyl-butyl ethers, di-iso-butyl ethers, di-tert-butyl ethers and the branched di-pentyl ethers.

As fatty entities especially suitable are phenoxy ethanol, the phenoxy propanols, isodecanols, isododecanols, and isotridecanols.

The hand disinfectant contains the at least one dissolving ether preferably in an amount of at least 20 w %, especially preferably of at least 40 w % and in particular of at least 50 w %.

Even more preferably, the hand disinfectant contains the at least one fatty entity in an amount of at least 1.5 times the solubility thereof in water.

It is advantageous if the fatty entity as a pure substance has a melting point, which is below the temperature of the human skin. It is important that the fatty entity will also separate as a liquid phase upon phase separation at temperatures, at which the agents are used. This may be possible due to a low solubility of water in the pure fatty entity or due to a low percentage of the active agent or due to the addition of a further solubilizing substance. The solubility of the fatty entities in water is so low so that some of these, or substances having a similar structure, are used in alcoholic hand disinfectants as conditioning agents, as so-called moisturizing agents, without the especially synergistic properties of these substances having been recognized. One example thereof is dodecanol, the moisturizing and conditioning agent of the hand disinfectant “Sterillium®”, a mixture of 1-propanol, 2-propanol, water, glycerol and dodecanol.

Phenoxy ethanol, the phenoxy propanols, isodecanols, isododecanols, isotridecanols, this is, hence, all compounds having at least one branch or an aliphatic or aromatic ring in their chain and, consequently, a melting point below 273 K, preferably below 283 K, especially preferably below 303 K and a boiling point above 373 K, are neither soluble in water nor are the cationic active agents such as, e.g., the quaternary ammonium compounds, guanidine and hexetidine soluble in the organic non-polymeric compounds.

The hand disinfectant preferably further contains up to 20% of a microbicidal cationic tenside. Especially preferably is this cationic tenside, acting as a synergistic agent, a quaternary ammonium compound, guanidine and/or hexetidine. Surprisingly, there has been found that an inventive fatty entity will enhance the effect of quaternary ammonium compounds, if these are present in the hand disinfectant at concentrations larger than the solubility thereof. Contrary to emulsions, in which these substances do not improve the effectiveness of quaternary ammonium compounds, they improve the effectiveness, if they are clearly dissolved in the product with a dissolving ether according to the invention. It is especially surprising that the moisturizing effect will be maintained.

There is generated a synergistic effect between dissolving ether, fatty entity and quaternary ammonium compound, guanidine or hexetidine, so that these quaternary ammonium compounds, guanidine and hexetidine known per se as not being sufficiently effective all of a sudden show a sufficiently microbicidal effectiveness. It is not the exact structure of the fatty entities that is important for the synergistic effect but rather, in one part, the fact that these have a detectable but low solubility in water of at least 0.01, preferably of at least 0.2, especially preferably of at least 0.5 w % up to 3, preferably up to 2, especially preferably up to 1.5 w %. The second important property results from the fact that the fatty entity is able to dissolve the alkyl chains of the quaternary ammonium compounds, guanidine and hexetidine but that the dissolution heat is low or even positive and that a miscibility will only be possible by the increase of entropy. This may be detected via an increase of viscosity.

The products according to the invention contain preferably from 0.1 w % to 20 w % of the at least one cationic tenside, which may in particular derive from the group of the monomeric or also of the polymeric cationic compounds. For that matter, especially suitable are quaternary ammonium compounds such as, e.g., benzalkonium chloride, benzethonium chloride, hexadecyl trimethyl ammonium chloride, mecitronium ethyl sulphate, dioctydimethyl ammonium chloride, didecyldimethyl ammonium chloride or the corresponding bromides or iodides, guanidine, chlorohexidine and the salts thereof, the gluconate, acetate or also the chloride and hexitine and hexamidine and the salts thereof, e.g., chlorides or bromides or iodides or sulphates, individually or in mixtures.

Especially preferred are products, which contain between 0.2 and 10 percent of the microbicidal cationic tenside, and especially preferred are products, which contain between 3 and 6 percent of microbicidal cationic tensides. The amount of poorly water-soluble moisturizing agents, in which the cationic microbicidal tenside must not be soluble, may fluctuate between 1 percent and 50 percent of the product. For that matter, contents from 1.5 percent to 40 percent are preferred, and especially preferred are contents between 15 percent and 30 percent. It is important that the two substances at the desired concentrations together are not soluble in water. The content of solubilizers depends on the two other substances in the product, this is the cationic active agent and moisturizing agent that is partially soluble in water.

Fatty entities and the cationic tenside are clearly dissolved in water with the solubilizing dissolving ether. The amount of dissolving ether, which is necessary in order to make the product clear, defines the amount of dissolving ether. There may, however, also be added larger amounts of dissolving ether to the product.

The water still present in the product is not necessary for the effectiveness of the products but rather improves skin tolerance.

The water content of the product should not be more than 90%, especially preferable not more than 80% and especially preferably not more than 75%. The minimum amount of water should not fall below 40%. Products having a water percentage of at least 50% are preferred, and products having a water content of at least 60% are especially preferred.

The invention will be explained in the following by way of some examples, the compositions of which being indicated in the following table 1:

TABLE 1

| | Exam- | Exam- | Exam- | Exam- | Exam- |
|---|---|---|---|---|---|
| Ingredient/property | ple 1 | ple 2 | ple 3 | ple 4 | ple 5 |
| Didecyl-dimethyl | 2.00 | 2.00 | 2.00 | 2.00 | |
| ammonium chloride | | | | | |
| Phenoxy propanol 3 | 20.00 | 3.00 | 2.00 | 3.00 | |
| Tripropylene glycol | | 33.50 | | | 50.00 |
| Dipropylene glycol | | | 25.00 | | |
| Ethoxy diglycol | 35.00 | 35.00 | | | |
| Water | 43.00 | 60.00 | 71.00 | 39.00 | 95.00 |
| Appearance: | Clear | Clear | Clear | Opaque, | clear |
| | | | | separated | |

The products according to the examples in the table were tested in regard to the microbicidal properties thereof in the hand disinfectant experiment according to EN 1500 and were at least as effective as the reference product, the 60% 2-propanol (vol/vol). The experiments were carried out with six samples per product. The data acquired in this way show whether a product is effective according to EN 1500, if the reduction factor in only six samples is at least as high as that of the reference. In detail, the following values were obtained:

TABLE 2

| | | Sufficiently | |
|---|---|---|---|
| | | effective | |
| | Reduction | according to | |
| Product | factor | EN 1500 | annotations |
| 60% 2-propanol | 4.1-4.6 | Reference | |
| (vol/vol). | | | |
| Example 1 | 4.5-5.0 | Yes | Too greasy on skin |
| Example 2 | 5.0-5.5 | Yes | Pleasant on skin |
| | | | following one-time |
| | | | application |
| Example 3 | 4.5-5.0 | Yes | Pleasant on skin |
| | | | following multi-time |
| | | | application; product |
| | | | is quickly absorbed |
| Example 4 | | | Unpleasant on skin |
| | | | and not stable |
| Example 5 | 4.2-4.7 | Yes | Product is slowly |
| | | | absorbed |

Apart from the microbicidal effectiveness in the practical experiment EN 1500, also the sensation on the skin was evaluated, as indicated in the table. Contrary to other products, which contain also a microbicidal concentration of glycols apart from a quaternary ammonium compound or a guanidine, the sensation on the skin with the products according to the invention is good. Following application, the skin is relaxed. The product according to example 3 is as quickly absorbed as required by the mode of operation in hospitals.

1. A hand disinfectant, comprising:
at least 50 wt % water; and
at least one dissolving ether,
wherein the at least one dissolving ether is an ether having a molecular weight of more than 107 Daltons, a melting point lower than 303 K, and a boiling point higher than 373 K, the solubility of which in water being at least 50% and wherein the ether reduces the solubility of calcium and magnesium adducts of proteins and amino sugars in water to at least one half.

2. A hand disinfectant according to claim 1, wherein the disinfectant further comprises at least one fatty entity, wherein the fatty entity is a non-polymeric compound selected from an ester, ether, ketone or alcohol, except for monoalcohols having a chain length of 1 to 8 carbon atoms, wherein the fatty entity has a low water solubility of at the most 3 wt % and at the minimum 0.01 wt %, wherein the fatty entity has a molecular weight of more than 107 Dalton, a melting point lower than 303 K, and a boiling point higher than 373 K, and wherein the content of the fatty entity is larger than the water solubility of the compound.

3. A hand disinfectant according to claim 1, wherein the fatty entity is an ester, ether, ketone or alcohol having at least one branch or an aliphatic or aromatic ring in the carbon skeleton.

4. A hand disinfectant according to claim 1, wherein the hand disinfectant further comprises up to 20% of a microbicidal cationic tenside.

5. A hand disinfectant according to claim 4, wherein the microbicidal cationic tenside is a quaternary ammonium compound, guanidine or hexetidine.

6. A hand disinfectant according to claim 2, wherein the dissolving ether and the fatty entity independently of each other have a melting point lower than 293 K.

7. A hand disinfectant according to claim 1, wherein the dissolving ether is a glycol ether.

8. A hand disinfectant according to claim 1, wherein the dissolving ether is included in an amount of at least 20 wt %.

9. A hand disinfectant according to claim 1, wherein the ether reduces the solubility of calcium and magnesium adducts of proteins and amino sugars in water to at least one third.

10. A hand disinfectant according to claim 1, wherein the ether reduces the solubility of calcium and magnesium adducts of proteins and amino sugars in water to at least one fourth.

11. A hand disinfectant according to claim 1, wherein the ether reduces the solubility of calcium and magnesium adducts of proteins and amino sugars in water to at least one fifth.

12. A hand disinfectant according to claim 2, wherein the dissolving ether and the fatty entity independently of each other have a melting point lower than 283 K.

13. A hand disinfectant according to claim 2, wherein the dissolving ether and the fatty entity independently of each other have a melting point lower than 273 K.

14. A hand disinfectant according to claim 7, wherein the glycol ether is a dipropylene glycol, a tripropylene glycol or a tetrapropylene glycol.

15. A hand disinfectant according to claim 1, wherein the dissolving ether is included in an amount of at least 50 wt %.

16. A hand disinfectant, comprising:
at least 50 wt % water;
at least one dissolving ether; and
at least one fatty entity,
wherein the at least one dissolving ether is an ether having a molecular weight of more than 107 Daltons, a melting point lower than 303 K, and a boiling point higher than 373 K, the solubility of which in water being at least 50% and wherein the ether reduces the solubility of calcium and magnesium adducts of proteins and amino sugars in water to at least one third.

17. A hand disinfectant according to claim 16, wherein the fatty entity is a non-polymeric compound selected from an ester, ether, ketone or alcohol, except for monoalcohols having a chain length of 1 to 8 carbon atoms.

18. A hand disinfectant according to claim 16, wherein the dissolving ether and the fatty entity independently of each other have a melting point lower than 283 K.

19. A hand disinfectant according to claim 16, wherein the dissolving ether is selected from a dipropylene glycol, a tripropylene glycol or a tetrapropylene glycol.

20. A hand disinfectant, comprising:
at least 50 wt % water;
at least one dissolving ether; and
up to 20% of a microbicidal cationic tenside,
wherein the at least one dissolving ether is an ether having a molecular weight of more than 107 Daltons, a melting point lower than 303 K, and a boiling point higher than 373 K, the solubility of which in water being at least 50% and wherein the ether reduces the solubility of calcium and magnesium adducts of proteins and amino sugars in water to at least one third.
